(19) United States
(12) Patent Application Publication
(10) Pub. No.: US 2020/0032101 A1
(43) Pub. Date: Jan. 30, 2020

(54) AQUEOUS EMULSION, AQUEOUS COATING COMPOSITION, AND SURFACE PROTECTIVE RESIN MEMBER

(71) Applicant: FUJI XEROX CO., LTD., Tokyo (JP)

(72) Inventors: Masahiro OKI, Kanagawa (JP); Hisae YOSHIZAWA, Kanagawa (JP); Fumiaki MERA, Kanagawa (JP); Takako KOBAYASHI, Kanagawa (JP); Shimpei TAKAGI, Kanagawa (JP)

(73) Assignee: FUJI XEROX CO., LTD., Tokyo (JP)

(21) Appl. No.: 16/372,703

(22) Filed: Apr. 2, 2019

(30) Foreign Application Priority Data
Jul. 26, 2018 (JP) 2018-140582

(51) Int. Cl. C09D 175/06; C08G 18/62; C08G 18/42; C08G 18/40; C08G 18/12; C09D 5/00

(52) U.S. Cl. CPC C09D 175/06; C08G 18/6279; C09D 5/00; C08G 18/4063; C08G 18/12; C08G 18/4277

(57) ABSTRACT

An aqueous emulsion includes a prepolymer that is a reaction product of a multifunctional isocyanate and an acrylic resin having fluorine atoms and hydroxyl groups and having an acid value in a range of 5 mgKOH/g to 100 mgKOH/g; and an aqueous solvent.

### CROSS-REFERENCE TO RELATED APPLICATIONS

This application is based on and claims priority under 35 USC 119 from Japanese Patent Application No. 2018-140582 filed Jul. 26, 2018.

### BACKGROUND

### (i) Technical Field

The present disclosure relates to an aqueous emulsion, an aqueous coating composition, and a surface protective resin member.

### (ii) Related Art

In order to suppress generation of surface scratches in various technical fields, surface protective resin members such as surface protective films have been disposed. Such surface protective resin members are used as, for example, protective films for protecting building materials (such as floor materials and wall materials), automotive members (such as automotive interiors, automotive bodies, and automotive door handles), sports goods, or musical instruments.

For example, Japanese Patent No. 5797954 discloses a water-dispersible urethane prepolymer that is a reaction product of (a) an organic isocyanate, (b) a polycarbonatediol, and (c) a compound having a single hydrophilic center and at least two isocyanate-reactive groups, wherein the polycarbonatediol (b) is a polycarbonatediol having a repeating unit represented by a specific formula (A) and end hydroxyl groups where 60 to 100 mol % of the repeating unit represented by the formula (A) is a repeating unit represented by a specific formula (B) or a specific formula (C), a ratio of the repeating unit represented by the formula (B) and the repeating unit represented by the formula (C) is 70:30 to 30:70 (molar ratio), and a ratio of primary end OH is 95 to 99.5%.

Japanese Laid Opened Patent Application Publication No. 2015-174928 discloses a self-healing formable emulsion composition that is obtained by a reaction of at least polyisocyanate (A), polyol (B), carboxyl-group-containing glycol (C), and an amine compound (D), wherein the polyisocyanate (A) is at least constituted by allophanate-modified polyisocyanate (a1) having 3.0 or more functional groups and organic diisocyanate (a2), and a molar ratio (a1) to (a2) satisfies (a1)/(a2)=80/20 to 20/80.

Japanese Patent No. 3889437 discloses a two-part reactive polyurethane composition, a cured coating formed from the composition, and a novel polyurethane prepolymer useful for the composition.

### SUMMARY

Surface protective resin members disposed on the surfaces of substrates to protect the surfaces desirably have scratch resistance, for example. Such members having scratch resistance are, for example, members having properties of being less likely to become scratched, and members having properties of healing scratches generated therein (self-healing properties).

Surface protective resin members also desirably have water resistance. Such members having water resistance have, for example, properties of repelling water by the surface (water repellency), or properties of suppressing degradation under exposure to water.

In summary, there has been a demand for formation of a surface protective resin member that has high scratch resistance and high water resistance.

Aspects of non-limiting embodiments of the present disclosure relate to an aqueous emulsion mixed with a water-dispersible multifunctional isocyanate to provide an aqueous coating composition for forming a surface protective resin member having high scratch resistance and high water resistance, compared with a coating composition composed of an acrylic resin having fluorine atoms and hydroxyl groups, a multifunctional isocyanate, and, as the solvent, an organic solvent alone.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an aqueous emulsion having a prepolymer that is a reaction product of a multifunctional isocyanate and an acrylic resin having fluorine atoms and hydroxyl groups and having an acid value in a range of 5 mgKOH/g to 100 mgKOH/g; and an aqueous solvent.

### DETAILED DESCRIPTION

Hereinafter, exemplary embodiments according to the present disclosure will be described. However, the exemplary embodiments are mere examples for practicing the present disclosure, and the present disclosure is not limited to the following exemplary embodiments.

### Aqueous Emulsion

An aqueous emulsion according to an exemplary embodiment includes a prepolymer and an aqueous solvent. The prepolymer is a reaction product of a multifunctional isocyanate and an acrylic resin having fluorine atoms and hydroxyl groups and having an acid value of 5 mgKOH/g or more and 100 mgKOH/g or less (hereafter, also referred to as the “specified acrylic resin”).

The aqueous emulsion according to this exemplary embodiment is further mixed with a water-dispersible multifunctional isocyanate, and used as a material for forming a surface protective resin member including an acrylic-urethane resin.

Since the aqueous emulsion according to this exemplary embodiment has the above-described features, during formation of such a surface protective resin member, the prepolymer and the water-dispersible multifunctional isocyanate react, to thereby provide a surface protective resin member having high scratch resistance (such as self-healing properties) and high water resistance (such as water repellency of repelling water).

The probable reason why such advantages are provided is as follows.

The prepolymer included in the aqueous emulsion according to this exemplary embodiment is a reaction product of the specified acrylic resin (a) having hydroxyl groups and the multifunctional isocyanate (c1). Specifically, OH groups in the specified acrylic resin (a) react with isocyanate groups in the multifunctional isocyanate (c1) to form urethane bonds (—NHCOO—). This results in formation of a structure in which the specified acrylic resin (a) is intermolecularly crosslinked via the multifunctional isocyanate (c1) (hereafter, referred to as the “first crosslinking”).

In addition, as described above, the aqueous emulsion is further mixed with the water-dispersible multifunctional isocyanate (c2) to form an acrylic-urethane resin. Specifically, the remaining OH groups in the prepolymer react with isocyanate groups in the water-dispersible multifunctional isocyanate (c2), to further form urethane bonds (—NHCOO—). This results in formation of a structure in which the specified acrylic resin (a) is intermolecularly crosslinked via the water-dispersible multifunctional isocyanate (c2) (hereafter, referred to as the “second crosslinking”).

In this way, the acrylic-urethane resin is synthesized so as to have the structure in which the specified acrylic resin (a) is intermolecularly crosslinked via the multifunctional isocyanate (c1) (the first crosslinking), and the structure in which the specified acrylic resin (a) is intermolecularly crosslinked via the water-dispersible multifunctional isocyanate (c2) (the second crosslinking). This is the probable reason why the resultant surface protective resin member exhibits scratch resistance (for example, self-healing properties of healing scratches temporarily generated therein).

On the other hand, the aqueous emulsion according to this exemplary embodiment includes a prepolymer and an aqueous solvent. The prepolymer has acid groups, such as carboxyl groups, introduced by the specified acrylic resin (a) having an acid value of 5 mgKOH/g or more and 100 mgKOH/g or less. These acid groups are at least partially neutralized so that the prepolymer exhibits self-emulsifiability in water, and this self-emulsifiability provides an emulsion including the prepolymer emulsified in the aqueous solvent.

In addition, the prepolymer includes fluorine atoms introduced by the specified acrylic resin (a). Fluorine atoms have a high affinity for water. For this reason, in the process of mixing the aqueous emulsion with the water-dispersible multifunctional isocyanate to form the surface protective resin member, fluorine atoms tend to be localized in a region closer to the aqueous solvent, namely, the surface region. In this way, the surface protective resin member in which fluorine atoms are localized in the surface region is formed, which probably results in high water resistance.

In this way, this exemplary embodiment provides an aqueous emulsion for forming a surface protective resin member having high scratch resistance and high water resistance.

As described above, this exemplary embodiment provides the structure in which fluorine atoms are localized in the surface regions, to thereby provide a surface protective resin member having high oil resistance (oil repellency of repelling organic solvents such as chemicals).

The aqueous emulsion according to this exemplary embodiment, which includes a prepolymer emulsified in an aqueous solvent, includes, as another solvent, no organic solvent or a reduced amount of organic solvent. This results in suppression of chemical odor (organic solvent odor) due to evaporation of organic solvent during formation of surface protective resin members. In addition, for example, in the case of forming surface protective resin members in an environment in the presence of persons, the necessity of ventilation apparatuses disposed for the purpose of reducing the adverse effects of chemical odor may be eliminated, or the ventilation conditions may be relaxed.

Hereinafter, components of the aqueous emulsion according to this exemplary embodiment will be described in detail.

The aqueous emulsion according to this exemplary embodiment is a resin material provided in an aqueous form, the resin material being used for forming a surface protective resin member having high scratch resistance and high water resistance.

Emulsifiability in an aqueous solvent is provided by the self-emulsifiability of the resin material itself, so that no surfactant or a reduced amount of surfactant may be used. Specifically, during synthesis of the prepolymer in a solvent (organic solvent), acid groups are introduced into the acrylic resin used for forming the prepolymer; subsequently, the prepolymer is synthesized; the acid groups are then neutralized; and an aqueous solvent is subsequently added to achieve phase inversion emulsification. After the phase inversion emulsification, the organic solvent is removed to provide an aqueous emulsion in which the prepolymer is emulsified in the aqueous solvent. The obtained aqueous emulsion is further mixed with a water-dispersible multifunctional isocyanate to provide an aqueous coating composition. The aqueous coating composition is applied and the second crosslinking is caused to thereby form a surface protective resin member. After the application, from the viewpoint of sufficiently achieving the extension reaction, the aqueous coating composition may be dried, without forced drying, in an environment at room temperature (for example, 22° C.) for a relatively long time. In order to accelerate the extension reaction, an amine compound (for example, isophoronediamine) may be added to the aqueous coating composition.

### Prepolymer

The prepolymer included in the aqueous emulsion according to this exemplary embodiment is the reaction product of synthesis components at least including a multifunctional isocyanate and an acrylic resin (a) having fluorine atoms and hydroxyl groups and having an acid value of 5 mgKOH/g or more and 100 mgKOH/g or less.

In the aqueous emulsion according to this exemplary embodiment, the ratio of the prepolymer in all the components except for the aqueous solvent is preferably 20 mass % or more and 100 mass % or less, more preferably 20 mass % or more and 55 mass % or less.

### Specified Acrylic Resin (a)

The specified acrylic resin has fluorine atoms and hydroxyl groups, and includes acid groups in such an amount that the acid value is 5 mgKOH/g or more and 100 mgKOH/g or less.

The specified acrylic resin may be synthesized by a reaction of synthesis components at least including, for example, an ethylenic monomer having a fluorine atom, an ethylenic monomer having an acid group (for example, a carboxyl group), and an ethylenic monomer having a hydroxyl group. The synthesis components may further include an ethylenic monomer not having a fluorine atom, a carboxyl group, or a hydroxyl group.

### Ethylenic Monomer Having Hydroxyl Group

Examples of the ethylenic monomer having a hydroxyl group include hydroxymethyl (meth)acrylate, hydroxyethyl (meth)acrylate, hydroxypropyl (meth)acrylate, hydroxybutyl (meth)acrylate, and N-methylolacrylamine.

Another monomer may be employed that has a group (that provides a side chain in the resultant polymer) having a large number of carbon atoms. This monomer is preferably, for example, a monomer obtained by ring-opening of an ε-lactone ring, preferably a monomer obtained by adding 3 moles or more and 5 moles or less of ε-caprolactone to 1 mole of hydroxymethyl (meth)acrylate.

In this Specification, “(meth)acrylic acid” encompasses both of acrylic acid and methacrylic acid; “(meth)acrylate” encompasses both of acrylate and methacrylate.

From the viewpoint of improving the scratch resistance of the surface protective resin member to be obtained, the ethylenic monomer having a hydroxyl group is preferably an ethylenic monomer having a hydroxyl group and a group (that provides a side chain of the resultant polymer) having 4 or more carbon atoms.

Specifically, the specified acrylic resin is preferably a polymer of an ethylenic monomer having a fluorine atom, an ethylenic monomer having a carboxyl group, an ethylenic monomer having a hydroxyl group and a group (that provides a side chain of the resultant polymer) having 4 or more carbon atoms, and an ethylenic monomer not having a fluorine atom, a carboxyl group, or a hydroxyl group.

In the ethylenic monomer having a hydroxyl group and a group (that provides a side chain of the resultant polymer) having 4 or more carbon atoms, the side-chain preferably has 4 or more and 8 or less carbon atoms.

### Ethylenic Monomer Having Acid Group

Examples of the ethylenic monomer having an acid group (such as a carboxyl group) include (meth)acrylic acid, crotonic acid, itaconic acid, fumaric acid, and maleic acid.

The ratio of the ethylenic monomer having an acid group may be changed such that the acid value of the specified acrylic resin satisfies the above-described range.

### Ethylenic Monomer not Having Fluorine Atom, Carboxyl Group, or Hydroxyl Group

Examples of the ethylenic monomer not having a fluorine atom, a carboxyl group, or a hydroxyl group include (meth)acrylic acid alkyl esters such as methyl (meth)acrylate, ethyl (meth)acrylate, propyl (meth)acrylate, butyl (meth)acrylate, n-propyl (meth)acrylate, n-butyl (meth)acrylate, isobutyl (meth)acrylate, 2-ethylhexyl (meth)acrylate, n-octyl (meth)acrylate, and n-dodecyl (meth)acrylate; vinyl halides such as vinyl chloride and vinyl bromide; vinyl cyanides such as acrylonitrile and methacrylonitrile; vinyl esters such as vinyl formate, vinyl acetate, and vinyl propionate; aromatic vinyl derivatives such as styrene, vinyltoluene, and α-methylstyrene; vinylidene halides such as vinylidene chloride and vinylidene fluoride; acrylic acid and salts thereof such as acrylic acid, sodium acrylate, and calcium acrylate; acrylic acid alkyl ester derivatives such as β-hydroxyethyl acrylate, dimethylaminoethyl acrylate, glycidyl acrylate, acrylamide, and N-methylolacrylamide; methacrylic acid and salts thereof such as methacrylic acid, sodium methacrylate, and calcium methacrylate; methacrylic acid alkyl ester derivatives such as methacrylamide, β-hydroxyethyl methacrylate, dimethylaminoethyl methacrylate, and glycidyl methacrylate; and acid anhydrides and imides such as maleic anhydride, methylmaleimide, and phenylmaleimide.

### Ethylenic Monomer Having Fluorine Atom

Examples of the ethylenic monomer having a fluorine atom include trifluoromethyl (meth)acrylate, 2,2,2-trifluoroethyl (meth)acrylate, 1,1,1,3,3,3-hexafluoro-2-propyl (meth)acrylate, perfluoroethylmethyl (meth)acrylate, perfluoropropylmethyl (meth)acrylate, polyperfluorobutylmethyl (meth)acrylate, perfluoropentylmethyl (meth)acrylate, perfluorohexylmethyl (meth)acrylate, perfluoroheptylmethyl (meth)acrylate, perfluorooctylmethyl (meth)acrylate, perfluorononylmethyl (meth)acrylate, perfluorodecylmethyl (meth)acrylate, perfluoroundecylmethyl (meth)acrylate, perfluorododecylmethyl (meth)acrylate, perfluorotridecylmethyl (meth)acrylate, perfluorotetradecylmethyl (meth)acrylate, 2-(trifluoromethyl)ethyl (meth)acrylate, 2-(perfluoroethyl)ethyl (meth)acrylate, 2-(perfluoropropyl)ethyl (meth)acrylate, 2-(perfluorobutyl)ethyl (meth)acrylate, 2-(perfluoropentyl)ethyl (meth)acrylate, 2-(perfluorohexyl)ethyl (meth)acrylate, 2-(perfluoroheptyl)ethyl (meth)acrylate, 2-(perfluorooctyl)ethyl (meth)acrylate, 2-(perfluorononyl)ethyl (meth)acrylate, 2-(perfluorotridecyl)ethyl (meth)acrylate, 2-(perfluorotetradecyl)ethyl (meth)acrylate, perfluorohexylethylene, hexafluoropropene, hexafluoropropene epoxide, and perfluoro(propyl vinyl ether).

The ethylenic monomer having a fluorine atom preferably does not have a group that reacts with a long-chain polyol (b) and a multifunctional isocyanate described later. The ethylenic monomer having a fluorine atom is preferably a monomer not having a group that reacts with (b) and (c1), or a monomer having a group that reacts with (b) and (c1) but that does not remain after polymerization.

A side chain having a fluorine atom may have 2 or more and 20 or less carbon atoms, for example. The carbon chain of the side chain having a fluorine atom may be linear or branched.

The number of fluorine atoms included in a single molecule of the polymerizable monomer having a fluorine atom is not particularly limited, but is preferably, for example, 1 or more and 25 or less, more preferably 3 or more and 17 or less.

In the specified acrylic resin (a), the fluorine atom content relative to the whole acrylic resin is preferably 0.1 mass % or more and 50 mass % or less, more preferably 1 mass % or more and 30 mass % or less, still more preferably 1 mass % or more and 22 mass % or less.

When the fluorine atom content is 0.1 mass % or more, higher water resistance and higher oil resistance tend to be achieved. On the other hand, when the fluorine atom content is 50 mass % or less, coatability on substrates tends to be ensured.

The ratio of the ethylenic monomer having a fluorine atom may be changed such that the fluorine atom content in the specified acrylic resin satisfies such a range.

The fluorine atom content of the specified acrylic resin is measured by X-ray photoelectron spectroscopy (XPS).

### Acid Value

The acid value of the specified acrylic resin (a) is 5 mgKOH/g or more and 100 mgKOH/g or less, preferably 5 mgKOH/g or more and 60 mgKOH/g or less, more preferably 20 mgKOH/g or more and 50 mgKOH/g or less.

When the acid value is 5 mgKOH/g or more, the prepolymer has high self-emulsifiability in the aqueous solvent, to thereby achieve a smaller emulsion particle size. On the other hand, when the acid value is 100 mgKOH/g or less, water resistance is ensured.

The acid value is the number of milligrams of potassium hydroxide for achieving neutralization of acid groups (such as carboxyl groups) in 1 g of the sample. In this exemplary embodiment, the acid value is measured in accordance with a method (potentiometric titration) defined in JIS K0070-1992.

Incidentally, a sample in a neutralized state is measured after being subjected to a reduced pressure (optionally further to heating) to remove the neutralizing agent, or treated with acid, to thereby turn the neutralized groups into acid groups (such as carboxyl groups). When the sample does not dissolve, a solvent such as dioxane or tetrahydrofuran (THF) is used.

### Hydroxyl Value

The hydroxyl value of the specified acrylic resin (a) is preferably 40 mgKOH/g or more and 280 mgKOH/g or less, more preferably 70 mgKOH/g or more and 200 mgKOH/g or less.

When the hydroxyl value is 40 mgKOH/g or more, a surface protective resin member having a high crosslink density is provided, so that high scratch resistance (such as self-healing properties) tends to be provided. On the other hand, when the hydroxyl value is 280 mgKOH/g or less, a surface protective resin member having appropriate flexibility is provided.

The ratio of the ethylenic monomer having a hydroxyl group may be changed such that the hydroxyl value of the specified acrylic resin satisfies such a range.

The hydroxyl value is the number of milligrams of potassium hydroxide for achieving acetylation of hydroxyl groups in 1 g of the sample. In this exemplary embodiment, the hydroxyl value is measured by a method (potentiometric titration) defined in JIS K0070-1992. When the sample does not dissolve, a solvent such as dioxane or tetrahydrofuran (THF) is used.

### Molecular Weight

The specified acrylic resin (a) preferably has a weight-average molecular weight of 5000 or more and 100000 or less, more preferably 10000 or more and 50000 or less.

When the specified acrylic resin (a) has a weight-average molecular weight of 5000 or more, a surface protective resin member having high scratch resistance (such as self-healing properties) tends to be provided. On the other hand, when the weight-average molecular weight is 100000 or less, a surface protective resin member having high flexibility tends to be provided.

The weight-average molecular weight of the specified acrylic resin (a) is measured by gel permeation chromatography (GPC). The molecular weight measurement by GPC is performed with a measurement apparatus GPC HLC-8120GPC manufactured by Tosoh Corporation, a column TSKGEL SUPERHM-M (15 cm) manufactured by Tosoh Corporation, and tetrahydrofuran (THF) solvent. The weight-average molecular weight is calculated from the measurement results with a molecular weight calibration curve created with monodisperse polystyrene standards.

The specified acrylic resin (a) is synthesized by, for example, mixing the above-described monomers, subjecting the monomers to standard radical polymerization or ionic polymerization, and subsequently purifying the resultant product.

### Long-Chain Polyol (b)

The prepolymer is preferably a reaction product of the specified acrylic resin (a), the multifunctional isocyanate (c1), and a polyol (long-chain polyol (b)) having plural hydroxyl groups linked together via a carbon chain having 6 or more carbon atoms.

When the long-chain polyol (b) is used, OH groups in the specified acrylic resin (a) and OH groups in the long-chain polyol (b) react with isocyanate groups in the multifunctional isocyanate (c1) to form urethane bonds (—NHCOO—). In other words, a structure is formed in which the specified acrylic resin (a) is intermolecularly crosslinked via the long-chain polyol (b) and the multifunctional isocyanate (c1). As a result, a surface protective resin member having high scratch resistance (such as self-healing properties) tends to be provided.

Incidentally, from the viewpoint of scratch resistance (such as self-healing properties) of the surface protective resin member, the prepolymer is preferably a reaction product of synthesis components in which the specified acrylic resin (a), the long-chain polyol (b), and the multifunctional isocyanate (c1) in total account for 90 mass % or more of all the synthesis components.

The long-chain polyol includes plural hydroxyl groups (—OH) linked together via a carbon chain having 6 or more carbon atoms (carbon atoms of a linear moiety linking hydroxyl groups together). In other words, in the long-chain polyol, all the hydroxyl groups are linked together via a carbon chain having 6 or more carbon atoms (carbon atoms of a linear moiety linking hydroxyl groups together).

The number of functional groups in the long-chain polyol (in other words, the number of hydroxyl groups included in a single molecule of the long-chain polyol) may be, for example, in a range of 2 or more and 5 or less, or 2 or more and 3 or less.

In the long-chain polyol, the carbon chain having 6 or more carbon atoms is a chain in which a linear group of linking hydroxyl groups together has 6 or more carbon atoms. The carbon chain having 6 or more carbon atoms is, for example, an alkylene group, or a divalent group that is a combination of at least one alkylene group and at least one group selected from —O—, —C(═O)—, and —C(═O)—O—. The long-chain polyol in which hydroxyl groups are linked together via a carbon chain having 6 or more carbon atoms preferably has a structure of —[CO(CH₂)ₙ₁O]ₙ₂—H (where n1 represents 1 or more and 10 or less (preferably 3 or more and 6 or less, more preferably 5), n2 represents 1 or more and 50 or less (preferably 1 or more and 35 or less, more preferably 1 or more and 10 or less)).

Examples of the long-chain polyol include polycaprolactonepolyols (specific examples include bifunctional polycaprolactonediols, trifunctional polycaprolactonetriols, and tetra- or higher functional polycaprolactonepolyols).

Examples of the bifunctional polycaprolactonediols include a compound having two groups each represented by —[CO(CH₂)ₙ₁₁O]ₙ₁₂—H (where n11 represents 1 or more and 10 or less (preferably 3 or more and 6 or less, more preferably 5); n12 represents 1 or more and 50 or less (preferably 4 or more and 35 or less)), and having a hydroxyl group at the end. In particular, preferred is a compound represented by the following general formula (1).

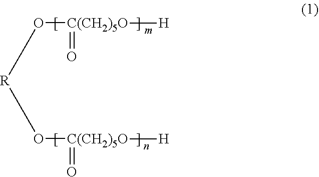

In the general formula (1), R represents an alkylene group, or a divalent group that is a combination of an alkylene group and at least one group selected from —O— and —C(═O)—; m and n each independently represent an integer of 1 or more and 35 or less.

In the general formula (1), the alkylene group included in the divalent group represented by R may be linear or branched. The alkylene group is, for example, preferably an alkylene group having 1 or more and 10 or less carbon atoms, more preferably an alkylene group having 1 or more and 5 or less carbon atoms.

The divalent group represented by R is preferably a linear or branched alkylene group having 1 or more and 10 or less carbon atoms (preferably 2 or more and 5 or less carbon atoms), preferably a group in which two linear or branched alkylene groups having 1 or more and 5 or less carbon atoms (preferably 1 or more and 3 or less carbon atoms) are coupled via —O— or —C(═O)— (preferably —O—). In particular, more preferred are divalent groups represented by *—C₂H₄—*, *—C₂H₄OC₂H₄—*, or *—C(CH₃)₂—(CH₂)₂—*. These divalent groups are bonded at the positions *.

m and n each independently represent an integer of 1 or more and 35 or less, preferably 2 or more and 10 or less.

Examples of the trifunctional polycaprolactonetriols include a compound having three groups each represented by —[CO(CH₂)ₙ₂₁O]ₙ₂₂—H (where n21 represents 1 or more and 10 or less (preferably 3 or more and 6 or less, more preferably 5), n22 represents 1 or more and 50 or less (preferably 1 or more and 28 or less)), and having a hydroxyl group at the end. In particular, preferred is a compound represented by the following general formula (2).

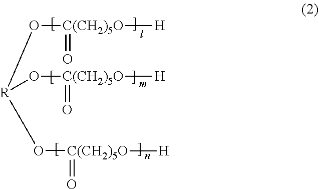

In the general formula (2), R represents a trivalent group that is provided by removing a hydrogen atom from an alkylene group, or a trivalent group that is a combination of a trivalent group provided by removing a hydrogen atom from an alkylene group, and at least one group selected from an alkylene group, —O—, and —C(═O)—. l, m, and n each independently represent an integer of 1 or more and 28 or less, and l+m+n satisfies 3 or more and 30 or less.

In the general formula (2), when R represents a trivalent group provided by removing a hydrogen atom from an alkylene group, the group may be linear or branched. For the trivalent group provided by removing a hydrogen atom from an alkylene group, the alkylene group is, for example, preferably an alkylene group having 1 or more and 10 or less carbon atoms, more preferably an alkylene group having 1 or more and 6 or less carbon atoms.

Alternatively, R may be a trivalent group that is a combination of a trivalent group provided by removing a hydrogen atom from the alkylene group, and at least one group selected from an alkylene group (for example, an alkylene group having 1 or more and 10 or less carbon atoms), —O—, and —C(═O)—.

The trivalent group represented by R is preferably a trivalent group provided by removing a hydrogen atom from a linear or branched alkylene group having 1 or more and 10 or less carbon atoms (preferably 3 or more and 6 or less carbon atoms). In particular, more preferred are trivalent groups represented by *—CH₂—CH(—*)—CH₂—*, CH₃—C(—*) (—*)—(CH₂)₂—*, or CH₃CH₂C(—*) (—*) (CH₂)₃—*. These trivalent groups are bonded at the positions *.

l, m, and n each independently represent an integer of 1 or more and 28 or less, preferably 2 or more and 10 or less. l+m+n satisfies 3 or more and 30 or less, preferably 6 or more and 30 or less.

The long-chain polyol preferably has a hydroxyl value of 30 mgKOH/g or more and 300 mgKOH/g or less, more preferably 50 mgKOH/g or more and 250 mgKOH/g or less. When the hydroxyl value is 30 mgKOH/g or more, a surface protective resin member having a high crosslink density is formed. On the other hand, when the hydroxyl value is 300 mgKOH/g or less, a surface protective resin member having appropriate flexibility tends to be provided.

The hydroxyl value is the number of milligrams of potassium hydroxide for achieving acetylation of hydroxyl groups in 1 g of the sample. In this exemplary embodiment, the hydroxyl value is measured in accordance with a method (potentiometric titration) defined in JIS K0070-1992. When the sample does not dissolve, a solvent such as dioxane or THF is used.

### Mass Ratio of Specified Acrylic Resin (a) to Long-Chain Polyol (b)

A mass ratio [a/b] of the specified acrylic resin (a) to the long-chain polyol (b) is preferably 20/80 or more and 80/20 or less, more preferably 25/75 or more and 75/25 or less, still more preferably 30/70 or more and 70/30 or less.

When the mass ratio [a/b] is 20/80 or more, a surface protective resin member having a high crosslink density is formed, and a surface protective resin member having high scratch resistance (such as self-healing properties) tends to be provided. On the other hand, when the mass ratio [a/b] is 80/20 or less, a surface protective resin member having appropriate flexibility tends to be provided.

### Multifunctional Isocyanate (c1)

The multifunctional isocyanate (c1) is a compound having plural isocyanate groups (—NCO), and reacts with, for example, hydroxyl groups of the specified acrylic resin (a) and hydroxyl groups of the long-chain polyol (b) to form urethane bonds (—NHCOO—). The multifunctional isocyanate (c1) functions as a crosslinking agent that intermolecularly crosslinks the specified acrylic resin (a), that crosslinks the specified acrylic resin (a) and the long-chain polyol (b), and that intermolecularly crosslinks the long-chain polyol (b).

The multifunctional isocyanate is not particularly limited, and examples thereof include bifunctional diisocyanates such as methylene diisocyanate, toluene diisocyanate, hexamethylene diisocyanate, and isophorone diisocyanate. Other preferred examples include multifunctional isocyanates such as a polymer of hexamethylene polyisocyanate having a biuret structure, an isocyanurate structure, an adduct structure, or an elastic structure, for example.

The multifunctional isocyanate may be selected from commercially available products such as polyisocyanate (DURANATE) manufactured by Asahi Kasei Corporation.

Such multifunctional isocyanates may be used alone or in combination of two or more thereof.

The prepolymer and a water-dispersible multifunctional isocyanate (c2) added later form an acrylic-urethane resin. Specifically, the prepolymer has the remaining hydroxyl groups, and these hydroxyl groups react with isocyanate groups in the water-dispersible multifunctional isocyanate (c2) to further form urethane bonds (—NHCOO—). This results in formation of a structure of crosslinking (second crosslinking) via the water-dispersible multifunctional isocyanate (c2).

Thus, during the reaction of the specified acrylic resin (a) and the multifunctional isocyanate (c1) (optionally, in addition, the long-chain polyol (b), for example), crosslinking with the multifunctional isocyanate (c1) (first crosslinking) is performed such that hydroxyl groups for the second crosslinking remain.

For this reason, the prepolymer (after the first crosslinking and before the second crosslinking) preferably has a hydroxyl value of 120 mgKOH/g or more and 170 mgKOH/g or less, more preferably 130 mgKOH/g or more and 170 mgKOH/g or less, still more preferably 135 mgKOH/g or more and 170 mgKOH/g or less.

From the above-described viewpoint, in the prepolymer, the ratio [OH_{A}/NCO_{C1}] of the number of moles [OH_{A}] of hydroxyl groups of the specified acrylic resin (a) to the number of moles [NCO_{C1}] of isocyanate groups of the multifunctional isocyanate (c1) is preferably 2 or more and 40 or less, more preferably 2 or more and 37 or less, still more preferably 2 or more and 35 or less.

### Aqueous Solvent

The aqueous emulsion according to this exemplary embodiment is an emulsion in which a prepolymer is emulsified in an aqueous solvent. The prepolymer is emulsified in the aqueous solvent to have the form of emulsion. As a result, the aqueous emulsion includes, as another solvent, no organic solvent or a reduced amount of organic solvent.

The aqueous solvent is a solvent having a water content of 50 mass % or more. Thus, the aqueous solvent may be constituted by water alone, or may be a solvent mixture including water and other liquids and having a water content of 50 mass % or more. The water content of the aqueous solvent is preferably 80 mass % or more and 100 mass % or less, more preferably 90 mass % or more and 100 mass % or less.

The aqueous emulsion according to this exemplary embodiment may further include, for example, additives described later.

### Preparation of Aqueous Emulsion

The method for preparing the aqueous emulsion according to this exemplary embodiment, which is not particularly limited, will be described with reference to an example.

In this exemplary embodiment, emulsifiability in the aqueous solvent is preferably provided by the self-emulsifiability of the prepolymer itself. Such a prepolymer having self-emulsifiability may be used, so that no surfactant or a reduced amount of surfactant is used.

Specifically, in an organic solvent (such as butyl acetate, ethyl acetate, methyl ethyl ketone, or acetone), the prepolymer is synthesized. The prepolymer is synthesized from, for example, as described above, the specified acrylic resin (a), the multifunctional isocyanate (c1), and optionally the long-chain polyol (b).

In this case, acid groups are introduced into the specified acrylic resin (a) used for forming the prepolymer, such that the acid value satisfies the above-described range.

Subsequently, the acid groups introduced into the prepolymer are neutralized. Examples of a neutralization agent used for neutralizing the acid groups include ammonia, sodium hydroxide, potassium hydroxide, methylamine, ethylamine, propylamine, butylamine, hexylamine, octylamine, ethanolamine, propanolamine, diethanolamine, N-methyldiethanolamine, dimethylamine, diethylamine, triethylamine, N,N-dimethylethanolamine, 2-dimethylamino-2-methyl-1-propanol, 2-amino-2-methyl-1-propanol, and morpholine. These agents may be used alone or in combination of two or more thereof.

After the neutralization of the acid groups, an aqueous solvent is added to achieve phase inversion emulsification. After the phase inversion emulsification, the organic solvent is removed to provide an aqueous emulsion in which the prepolymer is emulsified in the aqueous solvent. Incidentally, the organic solvent is removed with a rotary evaporator, for example.

### Aqueous Coating Composition

An aqueous coating composition according to an exemplary embodiment includes a prepolymer that is a reaction product of a multifunctional isocyanate (c1) and an acrylic resin (specified acrylic resin) (a) having fluorine atoms and hydroxyl groups and having an acid value of 5 mgKOH/g or more and 100 mgKOH/g or less; a water-dispersible multifunctional isocyanate (c2); and an aqueous solvent.

### Water-Dispersible Multifunctional Isocyanate (c2)

The water-dispersible multifunctional isocyanate (c2) is a compound having plural isocyanate groups (—NCO), and reacts with, for example, hydroxyl groups of the specified acrylic resin (a) and hydroxyl groups of the long-chain polyol (b) to form urethane bonds (—NHCOO—). The water-dispersible multifunctional isocyanate (c2) functions as a crosslinking agent that intermolecularly crosslinks the specified acrylic resin (a), that crosslinks the specified acrylic resin (a) and the long-chain polyol (b), and that intermolecularly crosslinks the long-chain polyol (b).

The water-dispersible multifunctional isocyanate (c2) is a water-dispersible compound. The “water-dispersible” isocyanate is a self-emulsifiable isocyanate that turns into an emulsion in water.

Examples of the water-dispersible multifunctional isocyanate (c2) include a compound provided as microcapsules of a multifunctional isocyanate to have water dispersibility, and a compound in which isocyanate groups are protected by a hydrophilic component.

The water-dispersible multifunctional isocyanate (c2) may be selected from commercially available products such as polyisocyanates manufactured by Asahi Kasei Corporation (DURANATE WB40-100, WB40-800, WT20-100, WT30-100, WT70-100, WR80-70P, and WE50-100).

Such water-dispersible multifunctional isocyanates (c2) may be used alone or in combination of two or more thereof.

The amount of the water-dispersible multifunctional isocyanate (c2) added to the aqueous coating composition is set so as to sufficiently cause crosslinking (second crosslinking) of hydroxyl groups in the prepolymer and isocyanate groups in the water-dispersible multifunctional isocyanate (c2).

For this reason, in the aqueous coating composition (1), the ratio [OH_{PRE}/NCO_{C2}] of the number of moles [OH_{PRE}] of OH groups of the prepolymer (after the first crosslinking and before the second crosslinking) to the number of moles [NCO_{C2}] of NCO groups of the water-dispersible multifunctional isocyanate (c2) is preferably 0.8 or more and 1.2 or less, more preferably 0.9 or more and 1.2 or less, still more preferably 0.9 or more and 1.1 or less.

### Additives

In this exemplary embodiment, the above-described aqueous emulsion and aqueous coating composition may include additives. Examples of the additives include an antistatic agent, a reaction accelerator for accelerating the reaction of hydroxyl groups (—OH) in the specified acrylic resin (a) and the long-chain polyol (b) and isocyanate groups (—NCO) in the multifunctional isocyanate (c1), and an amine compound for accelerating the extension reaction.

### Antistatic Agent

Specific examples of the antistatic agent include cationic surfactants (such as tetraalkylammonium salts, trialkylbenzylammonium salts, hydrochloric acid salts of alkylamines, and imidazolium salts), anionic surfactants (such as alkylsulfonic acid salts, alkylbenzenesulfonic acid salts, and alkylphosphates), nonionic surfactants (such as glycerol fatty acid ester, polyoxyalkylene ether, polyoxyethylene alkylphenyl ether, N,N-bis-2-hydroxyethylalkylamine, hydroxyalkylmonoethanolamine, polyoxyethylenealkylamine, fatty acid diethanolamide, and polyoxyethylenealkylamine fatty acid ester), and amphoteric surfactants (such as alkylbetaine and alkylimidazolium betaine).

Other examples of the antistatic agent include quaternary ammonium-containing compounds.

Specific examples include tri-n-butylmethylammonium bistrifluoromethanesulfoneimide, lauryltrimethylammonium chloride, octyldimethylethylammonium ethylsulfate, didecyldimethylammonium chloride, lauryldimethylbenzylammonium chloride, stearyldimethylhydroxyethylammonium para-toluenesulfonate, tributylbenzylammonium chloride, lauryldimethylaminoacetic acid betaine, lauroylamide propylbetaine, octanamide propylbetaine, and polyoxyethylenestearylamine hydrochloric acid salts. Of these, preferred is tri-n-butylmethylammonium bistrifluoromethanesulfoneimide.

Other examples of the antistatic agent include high-molecular-weight antistatic agents.

Examples of the high-molecular-weight antistatic agents include polymers obtained by polymerizing quaternary ammonium base-containing acrylates, polystyrenesulfonic acid-based polymers, polycarboxylic acid-based polymers, polyetherester-based polymers, ethylene oxide-epichlorohydrin-based polymers, and polyetheresteramide-based polymers.

Examples of the polymers obtained by polymerizing quaternary ammonium base-containing acrylates include polymers at least having the following constitutional unit (A).

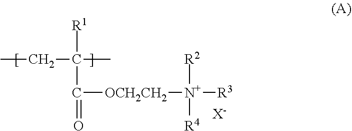

In the constitutional unit (A), R¹ represents a hydrogen atom or a methyl group; R², R³, and R⁴ each independently represent an alkyl group; and X⁻ represents an anion.

The high-molecular-weight antistatic agents can be polymerized by known methods.

Such a high-molecular-weight antistatic agent may be a single polymer species synthesized from the same polymerizable monomers, or may be a combination of two or more polymer species synthesized from different polymerizable monomers.

In this exemplary embodiment, the surface protective resin member is preferably formed so as to have a surface resistance in a range of 1×10⁹Ω/□ or more and 1×10¹⁴Ω/□ or less, and have a volume resistivity in a range of 1×10⁸ Ω/□ or more and 1×10¹³ Ωcm or less.

The surface resistance and the volume resistivity are measured with HIRESTA UPMCP-450 equipped with a UR probe manufactured by DIA Instruments Co., Ltd., in an environment at 22° C. and 55% RH, in accordance with JIS-K6911.

When such an antistatic agent is contained, for example, the type or content of the antistatic agent may be changed, to thereby control the surface resistance and the volume resistivity of the surface protective resin member.

The antistatic agents may be used alone or in combination of two or more thereof.

### Reaction Accelerator

Examples of the reaction accelerator for accelerating the reaction of hydroxyl groups (—OH) in the specified acrylic resin (a) and the long-chain polyol (b) and isocyanate groups (—NCO) in the multifunctional isocyanate (c1) include metal catalysts such as tin or bismuth. Examples of these catalysts include NEOSTANN U-28, U-50, U-600, tin(II) stearate manufactured by Nitto Kasei Co., Ltd.; and XC-C277 and XK-640 manufactured by Kusumoto Chemicals, Ltd.

### Amine Compound

During formation of the surface protective resin member, in order to accelerate the extension reaction, an amine compound may be added to the aqueous emulsion or the aqueous coating composition. Examples of the amine compound include aliphatic diamines such as ethylenediamine, propylenediamine, hexamethylenediamine, and triethylenetetramine; alicyclic diamines such as isophoronediamine and piperazine; aromatic diamines such as diphenyldiamine; and triamine.

### Surface Protective Resin Member

### First Exemplary Embodiment

A surface protective resin member according to a first exemplary embodiment is a cured article of the aqueous coating composition according to the above-described exemplary embodiment.

The surface protective resin member according to the first exemplary embodiment formed by curing the aqueous coating composition has high scratch resistance (such as self-healing properties) and high water resistance (such as water repellency of repelling water).

### Second Exemplary Embodiment

In this exemplary embodiment, the surface protective resin member is not limited to that provided by using the aqueous coating composition according to the above-described exemplary embodiment.

Specifically, a surface protective resin member according to a second exemplary embodiment is a reaction product of a water-dispersible multifunctional isocyanate and a prepolymer that is a reaction product of a multifunctional isocyanate C1 and an acrylic resin having fluorine atoms and hydroxyl groups and having an acid value of 5 mgKOH/g or more and 100 mgKOH/g or less.

The surface protective resin member having these features according to the second exemplary embodiment has high scratch resistance (such as self-healing properties) and high water resistance (such as water repellency of repelling water).

### Formation of Surface Protective Resin Member

The surface protective resin members according to the first exemplary embodiment and the second exemplary embodiment can be formed by, for example, applying and drying the aqueous coating composition according to the above-described exemplary embodiment.

Incidentally, after the application of the aqueous coating composition, in order to sufficiently achieve the extension reaction, the applied composition is preferably dried, without forced drying, in an environment at room temperature (for example, 22° C.) for a relatively long time.

From the viewpoint of improving the bonding between the aqueous coating composition and the substrate, an aqueous primer may be applied onto the substrate before application of the aqueous coating composition. Examples of the aqueous primer include acryl- or urethane-based commercially available products such as WEM-031U, WEM-202U, WEM-321U, WEM-3000, WEM-290A, WEM-505C, and WEM-506C (manufactured by Taisei Fine Chemical Co., Ltd.).

The thickness of the surface protective resin member is not particularly limited, and may be, for example, 1 μm or more and 100 μm or less, may be 10 μm or more and 30 μm or less.

### Martens Hardness

The surface protective resin members according to the exemplary embodiments (first and second exemplary embodiments) each preferably have a Martens hardness at 23° C. of 0.5 N/mm² or more and 220 N/mm² or less, more preferably 1 N/mm² or more and 80 N/mm² or less, still more preferably 1 N/mm² or more and 5 N/mm² or less. When the Martens hardness (23° C.) is 0.5 N/mm² or more, the resin member tends to maintain the designed shape. On the other hand, when the Martens hardness (23° C.) is 220 N/mm² or less, the probability of healing scratches (namely self-healing properties) tends to be improved.

### Recovery Ratio

The surface protective resin members according to the exemplary embodiments (first and second exemplary embodiments) each preferably have a recovery ratio at 23° C. of 70% or more and 100% or less, more preferably 80% or more and 100% or less, still more preferably 90% or more and 100% or less. The recovery ratio is an index of self-healing properties (properties of recovering from strain (caused by application of a stress) within 1 min after removal of the stress, namely the degree of healing scratches) of resin materials. When the recovery ratio (23° C.) is 70% or more, the probability of healing scratches (namely, self-healing properties) is improved.

In the surface protective resin member, the Martens hardness and the recovery ratio are adjusted by controlling, for example, the hydroxyl value of the specified acrylic resin (a), the number of carbon atoms of a chain linking together hydroxyl groups in the long-chain polyol (b), the ratio of the specified acrylic resin (a) to the long-chain polyol (b), the number of functional groups (isocyanate groups) in the multifunctional isocyanate (c1), the ratio of the specified acrylic resin (a) to the multifunctional isocyanate (c1), or the ratio of the prepolymer to the water-dispersible multifunctional isocyanate (c2).

The Martens hardness and the recovery ratio are measured with an instrument, FISCHERSCOPE HM2000 (manufactured by Fischer). A surface protective resin member (sample) is fixed on a slide glass with an adhesive, and mounted on the instrument. To the surface protective resin member, a load is applied and increased to 0.5 mN over a period of 15 seconds at a predetermined measurement temperature (for example, 23° C.), and the load of 0.5 mN is maintained for 5 seconds. In this process, the maximum displacement is measured as h1. Subsequently, the load is decreased to 0.005 mN over a period of 15 seconds, and the load of 0.005 mN is maintained for 1 minute during which the displacement is measured as h2. From h1 and h2, the recovery ratio is calculated using [(h1−h2)/h1]×100(%). In this measurement, a load-displacement curve is created, and this curve is used to determine Martens hardness.

### Contact Angle

In each of the surface protective resin members according to the exemplary embodiments (first and second exemplary embodiments), from the viewpoint of water resistance, the surface preferably has a contact angle with water of 90° or more and 150° or less, more preferably 95° or more and 150° or less, still more preferably 100° or more and 150° or less.

In each of the surface protective resin members according to the exemplary embodiments (first and second exemplary embodiments), from the viewpoint of oil resistance, the surface preferably has a contact angle with oleic acid of 55° or more and 70° or less, more preferably 57° or more and 70° or less, still more preferably 60° or more and 70° or less.

The contact angles with water or oleic acid are measured with a contact angle meter (manufactured by Kyowa Interface Science Co., Ltd., Model: CA-X) at 23° C.

### Applications

The surface protective resin members according to the exemplary embodiments (first and second exemplary embodiments) are applicable, as surface protective members, to, for example, articles that may become scratched during contacts with other objects.

Specific examples of the articles include building materials (such as floor materials and wall materials); automotive members (such as automotive interiors, automotive bodies, and automotive door handles); screens and other bodies in portable devices (such as cellular phones and portable gaming devices); screens of touch panels; containers (such as suitcases); containers of cosmetics; glasses (such as frames and lenses); sports goods (such as golf clubs and rackets); writing materials (such as fountain pens); musical instruments (such as the exteriors of pianos); tools for storing clothing (such as hangers); members of image forming apparatuses such as copy machines (such as transfer members, for example, transfer belts); and leather products (such as bags and satchels).

### EXAMPLES

Hereinafter, the present disclosure will be described further in detail with reference to Examples and Comparative Examples. However, the present disclosure is not limited to the following Examples. Incidentally, the terms “parts” in the following description are based on mass unless otherwise specified.

### Example 1

Synthesis of Fluorine-Containing Acrylic Resin (a)-1

A monomer solution is charged into a dropping funnel, the monomer solution being composed of 534.1 parts of hydroxyethyl methacrylate (HEMA, side chain: 3 carbon atoms), 486.3 parts of butyl methacrylate (BMA, ethylenic monomer not having a fluorine atom, a carboxyl group, or a hydroxyl group), 295.6 parts of CHEMINOX FAMAC6 (fluorine-containing monomer, manufactured by UNIMATEC CO., LTD., compound name: 2-(perfluorohexyl)ethyl methacrylate), and 86.1 parts of methacrylic acid (ethylenic monomer having a carboxyl group). The monomer solution is dropped, in a nitrogen atmosphere under reflux, into 300 parts of butyl acetate (organic solvent) heated at 110° C. under stirring over a period of 3 hours to achieve polymerization. In addition, a solution composed of 135 parts of methyl ethyl ketone (organic solvent) and 3 parts of a polymerization initiator (benzoyl peroxide, BPO) is dropped over a period of 1 hour, to complete the reaction. During the reaction, the reaction solution is always kept at 110° C. and continuously stirred.

In this way, a fluorine-containing acrylic resin (a)-1 is obtained.

For the fluorine-containing acrylic resin (a)-1, its acid value [mgKOH/g] and hydroxyl value [mgKOH/g] measured by the above-described methods are described in Table 1. In addition, the molar ratio of the monomers (FAMAC6/HEMA/BMA/methacrylic acid) and the fluorine atom content [mass %] of the acrylic resin are described in Table 1.

### Preparation of Aqueous Emulsion

In this preparation, 353.3 parts of the fluorine-containing acrylic resin (a)-1 (hydroxyl value: 170, solid content: 45 mass %), 371 parts of a long-chain polyol (PLACCEL 205, polycaprolactonediol, hydroxyl value: 210, manufactured by Daicel Corporation), 14.5 parts of a multifunctional isocyanate (DURANATE TLA100, NCO groups (mass %): 23.3%, manufactured by Asahi Kasei Corporation), and 120 parts of methyl ethyl ketone (MEK, organic solvent) are charged into a reaction vessel equipped with a reflux condenser, a thermometer, and a stirrer, and subjected to a urethane-forming reaction at 80° C. for 4 hours, to obtain a prepolymer solution (1).

To the prepolymer solution (1) set at 30° C., 170 parts of 1 N aqueous ammonia is dropped to cause a neutralization reaction, and subsequently 1000 parts of ion-exchanged water is dropped, to prepare an emulsion of the prepolymer solution. Subsequently, MEK is removed (driven off) to obtain an aqueous prepolymer emulsion (1) having a solid content of 30 mass %.

In the aqueous prepolymer emulsion (1), the ratio [OH_{A}/NCO_{C1}] of the number of moles [OH_{A}] of OH groups of the fluorine-containing acrylic resin (a)-1 to the number of moles [NCO_{C1}] of NCO groups of the multifunctional isocyanate is described in Table 1. In addition, the hydroxyl value [mgKOH/g] of the prepolymer (prepolymer before the second crosslinking) is described in Table 1.

### Preparation of Aqueous Coating Composition

To 100 parts of the aqueous prepolymer emulsion (1), 31.4 parts of a water-dispersible multifunctional isocyanate (DURANATE WT20-100, NCO groups (mass %): 14.3%, manufactured by Asahi Kasei Corporation) is added, and stirred at 1000 rpm for 3 minutes, to obtain an aqueous coating composition (1).

In the aqueous coating composition (1), the ratio [OH_{PRE}/NCO_{C2}] of the number of moles [OH_{PRE}] of OH groups of the prepolymer to the number of moles [NCO_{C2}] of NCO groups of the water-dispersible multifunctional isocyanate is described in Table 2.

### Formation of Protective Film

A substrate (polyimide film) is coated with an aqueous primer (WEM-031U, manufactured by Taisei Fine Chemical Co., Ltd.) such that the resultant film having been dried has a thickness of 5 μm. Subsequently, the aqueous coating composition (1) is applied such that the resultant film having been dried has a thickness of 30 μm, and dried at room temperature (22° C.) for 24 hours, to form a protective film (1) on the substrate.

### Properties of Protective Film

For the protective film (1), the Martens hardness [N/mm², 23° C.] and the recovery ratio [%, 23° C.] measured by the above-described methods are described in Table 2. In addition, the contact angles with water or oleic acid measured in the following manner are described in Table 2.

The contact angles are measured with a contact angle meter (manufactured by Kyowa Interface Science Co., Ltd., Model: CA-X) at 23° C.

### Examples 2 to 15

In Examples 2 to 15, protective films are formed as in Example 1 except that the following parameters are changed. The compositions, properties, and evaluation results are described in Tables below.

In Examples 2 and 3, the monomer ratio in synthesis of the acrylic resin (a)-1 (molar ratio of fluorine atom-containing monomer/hydroxyl group-containing monomer/monomer not containing fluorine atom, hydroxyl group, or carboxyl group/carboxyl group-containing monomer) in Example 1 is changed to the ratios described in Table 1.

In Examples 4 and 5, the mass ratio of the acrylic resin (a) to the long-chain polyol (b) in preparation of the aqueous emulsion in Example 1 is changed as described in Table 1.

In Examples 6 and 7, the monomer ratio in synthesis of the acrylic resin (a)-1 (molar ratio of fluorine atom-containing monomer/hydroxyl group-containing monomer/monomer not containing fluorine atom, hydroxyl group, or carboxyl group/carboxyl group-containing monomer) in Example 1 is changed to the ratios described in Table 1.

In Examples 8 to 10, the long-chain polyol in preparation of the aqueous emulsion in Example 1 is changed to long-chain polyols described in Table 1.

PLACCEL 205 is a polycaprolactonediol having a hydroxyl value of 210, manufactured by Daicel Corporation. PLACCEL 230 is a polycaprolactonediol having a hydroxyl value of 190, manufactured by Daicel Corporation. PLACCEL 305 is a polycaprolactonetriol having a hydroxyl value of 305, manufactured by Daicel Corporation. PLACCEL 410 is a polycaprolactonetetraol having a hydroxyl value of 225, manufactured by Daicel Corporation.

In Example 11, the long-chain polyol in preparation of the aqueous emulsion in Example 1 and another long-chain polyol are used. Specifically, PLACCEL 205 and PLACCEL 305 are used in a mass ratio of 50:50.

In Examples 12 to 15, the ratio OH_{A}/NCO_{C1} and the prepolymer hydroxyl value in preparation of the aqueous emulsion in Example 1 are changed as described in Table 1.

### Comparative Examples 1 and 2

In Comparative Examples 1 and 2, protective films are formed as in Example 1 except that the following parameter is changed. The compositions, properties, and evaluation results are described in Tables below.

In Comparative Examples 1 and 2, the monomer ratio in synthesis of the acrylic resin (a)-1 (molar ratio of fluorine atom-containing monomer/hydroxyl group-containing monomer/monomer not containing fluorine atom, hydroxyl group, or carboxyl group/carboxyl group-containing monomer) in Example 1 is changed to ratios described in Table 1.

### Evaluation Tests

### Measurement of Emulsion Particle Size

The aqueous emulsions obtained in Examples and Comparative Examples are measured for emulsion particle size [μm] in the following manner. The results are described in Table 2.

An aqueous emulsion (0.5 g) is mixed with 10 g of distilled water, and measured with a particle size distribution analyzer (LA-960: manufactured by HORIBA, Ltd.).

In Table 2, the term “Disintegration” stands for poor stability of emulsion: emulsion particles become coarse with time and the particle shape is not maintained.

### Evaluation of Self-Healing Properties

The protective films obtained in Examples and Comparative Examples are evaluated for self-healing properties in the following manner. The results are described in Table 2.

Scratching tests are performed in accordance with Determination of mar resistance (ISO12137-2), with a sapphire stylus (0.03 mm) under loads of 0 g to 200 g at a movement speed of 600 mm/min. Scratches caused by scratching are observed with a loupe to measure the time taken for the scratches to disappear.

### Evaluation System

A: less than 5 seconds

B: 5 seconds or more and less than 10 minutes

C: 10 minutes or more

### Evaluation of Water Resistance

The protective films obtained in Examples and Comparative Examples are evaluated for water resistance in the following manner. The results are described in Table 2.

The protective films are immersed in pure water at 40° C. for 120 hours in accordance with JIS K5600-6-1-7. The protective films having been immersed are sufficiently dried and subsequently subjected to visual inspection of appearance and cross-cut evaluation according to JIS K5600-5-6.

Evaluation System

A: no changes are visually detected and the cross-cut grade is 0 or 1 (no flaking)

B: no changes are visually detected and the cross-cut grade is 3 or 4 (partial flaking)

C: cloudiness is visually detected or the cross-cut grade is 5 (flaking occurs almost entirely)

### Evaluation of Chemical Resistance

The protective films obtained in Examples and Comparative Examples are evaluated for chemical resistance in the following manner. The results are described in Table 2.

The protective films are treated by being brought into contact with a 5% sodium hydroxide solution at 55° C. for 24 hours in accordance with JIS K5600-6-1-8. Subsequently, the protective films are rinsed with pure water, sufficiently dried, and then subjected to visual inspection of appearance and measurement of contact angle with water. The difference of contact angles before and after this treatment is calculated.

Evaluation System

A: no changes are visually detected and the contact angle difference is less than 10°

B: no changes are visually detected and the contact angle difference is 10° or more and less than 20°

C: dissolution, flaking, or cloudiness is visually detected, or the contact angle difference is 20° or more

TABLE 1

| | | Emulsion | | | | | | | | | | | |
|---|---|---|---|---|---|---|---|---|---|---|---|---|---|
| | | Prepolymer | | | | | | | | | | | |
| | | Acrylic resin (a) | | | | Long-chain polyol (b) | | | Multifunctional | | | | |
| | | | | | Acrylic | (Employed | | | isocyanate (c1) | | | Pre- | |
| | | | | | resin | material) | | (a)/ | | | Ratio | polymer | |
| | | Acid | Hydroxyl | Monomer | F atom | polycapro- | Molec- | (b) | Em- | NCO | OH_{A}/ | Hydroxyl | |
| | | value | value | molar | content | lactone- | ular | mass | ployed | mass | NCO_{C1} | value | Sol- |
| | | mgKOH/g | mgKOH/g | ratio (*0) | mass % | polyol | weight | ratio | material | % | (*1) | mgKOH/g | vent |
| Example | 1 | 40 | 170 | 5/30/25/0.71 | 12.0 | PLACCEL 205 | 530 | 30/70 | TLA100 | 23.3 | 24.0 | 163.2 | Water |
| | 2 | 40 | 170 | 1/30/25/0.71 | 2.7 | PLACCEL 205 | 530 | 30/70 | TLA100 | 23.3 | 24.0 | 163.2 | Water |
| | 3 | 40 | 170 | 10/30/25/0.71 | 20.9 | PLACCEL 205 | 530 | 30/70 | TLA100 | 23.3 | 24.0 | 163.2 | Water |
| | 4 | 40 | 170 | 5/30/25/0.71 | 12.0 | PLACCEL 205 | 530 | 20/80 | TLA100 | 23.3 | 24.0 | 163.2 | Water |
| | 5 | 40 | 170 | 5/30/25/0.71 | 12.0 | PLACCEL 205 | 530 | 80/20 | TLA100 | 23.3 | 24.0 | 163.2 | Water |
| | 6 | 5 | 170 | 5/30/25/0.09 | 12.7 | PLACCEL 205 | 530 | 30/70 | TLA100 | 23.3 | 24.0 | 163.2 | Water |
| | 7 | 100 | 170 | 5/30/25/1.78 | 10.9 | PLACCEL 205 | 530 | 30/70 | TLA100 | 23.3 | 24.0 | 163.2 | Water |
| | 8 | 40 | 170 | 5/30/25/0.71 | 12.0 | PLACCEL 230 | 3000 | 30/70 | TLA100 | 23.3 | 24.0 | 163.2 | Water |
| | 9 | 40 | 170 | 5/30/25/0.71 | 12.0 | PLACCEL 305 | 550 | 30/70 | TLA100 | 23.3 | 24.0 | 163.2 | Water |
| | 10 | 40 | 170 | 5/30/25/0.71 | 12.0 | PLACCEL 410 | 1000 | 30/70 | TLA100 | 23.3 | 24.0 | 163.2 | Water |
| | 11 | 40 | 170 | 5/30/25/0.71 | 12.0 | PLACCEL 205 | 530 | 30/70 | TLA100 | 23.3 | 24.0 | 163.2 | Water |
| | | | | | | PLACCEL 305 | 550 | | | | | | |
| | 12 | 40 | 170 | 5/30/25/0.71 | 12.0 | PLACCEL 205 | 530 | 30/70 | TLA100 | 23.3 | 2.6 | 122.4 | Water |
| | 13 | 40 | 170 | 5/30/25/0.71 | 12.0 | PLACCEL 205 | 530 | 30/70 | TLA100 | 23.3 | 39.0 | 165.8 | Water |
| | 14 | 40 | 170 | 5/30/25/0.71 | 12.0 | PLACCEL 205 | 530 | 30/70 | TLA100 | 23.3 | 49.0 | 166.6 | Water |
| | 15 | 40 | 170 | 5/30/25/0.71 | 12.0 | PLACCEL 205 | 530 | 30/70 | TLA100 | 23.3 | 1.9 | 110.5 | Water |
| Compar- | 1 | 3 | 170 | 5/30/25/0.05 | 12.8 | PLACCEL 205 | 530 | 30/70 | TLA100 | 23.3 | 24.0 | 163.2 | Water |
| ative | 2 | 110 | 170 | 5/30/25/1.96 | 10.7 | PLACCEL 205 | 530 | 30/70 | TLA100 | 23.3 | 24.0 | 163.2 | Water |
| Example | | | | | | | | | | | | | |

TABLE 2

| | | Coating composition | | | | | | | | | | |
|---|---|---|---|---|---|---|---|---|---|---|---|---|
| | | Water-dispersible multifunctional | | | Properties of protective film | | | | Evaluation | | | |
| | | isocyanate (c2) | | | | | Contact angle | | Emulsion | | | |
| | | | | Ratio OH_{PRE}/ | Martens | Recovery | [°] | | particle | Self- | | |
| | | Employed | NCO | NCO_{C2} | hardness | ratio | | Oleic | size | healing | Water | Chemical |
| | | material | mass % | (*2) | N/mm² | % | Water | acid | nm | properties | resistance | resistance |
| Example | 1 | WT20-100 | 14.3 | 0.9 | 3.5 | 88 | 106 | 70 | 90 | A | A | A |
| | 2 | WT20-100 | 14.3 | 0.9 | 3.4 | 85 | 101 | 65 | 93 | A | B | B |
| | 3 | WT20-100 | 14.3 | 0.9 | 3.4 | 83 | 106 | 68 | 92 | B | A | A |
| | 4 | WT20-100 | 14.3 | 0.9 | 3.2 | 92 | 104 | 67 | 95 | A | A | B |
| | 5 | WT20-100 | 14.3 | 0.9 | 4.0 | 77 | 101 | 64 | 107 | B | B | B |
| | 6 | WT20-100 | 14.3 | 0.9 | 3.5 | 84 | 102 | 65 | 145 | A | A | B |
| | 7 | WT20-100 | 14.3 | 0.9 | 3.2 | 84 | 101 | 63 | 87 | A | B | B |
| | 8 | WT20-100 | 14.3 | 0.9 | 3.6 | 81 | 103 | 64 | 116 | B | A | B |
| | 9 | WT20-100 | 14.3 | 0.9 | 3.4 | 83 | 102 | 63 | 98 | B | A | B |
| | 10 | WT20-100 | 14.3 | 0.9 | 3.5 | 82 | 102 | 63 | 89 | B | A | B |
| | 11 | WT20-100 | 14.3 | 0.9 | 3.4 | 83 | 103 | 62 | 105 | B | A | B |
| | 12 | WT20-100 | 14.3 | 0.9 | 3.3 | 76 | 102 | 63 | 99 | B | B | B |
| | 13 | WT20-100 | 14.3 | 0.9 | 3.2 | 80 | 101 | 61 | 104 | B | B | B |
| | 14 | WT20-100 | 14.3 | 0.9 | 3.0 | 79 | 100 | 60 | 105 | B | B | B |
| | 15 | WT20-100 | 14.3 | 0.9 | 3.0 | 74 | 101 | 60 | 100 | B | B | B |
| Comparative | 1 | WT20-100 | 14.3 | 0.9 | 2.8 | 68 | 87 | 53 | Disintegration | — | — | — |
| Example | 2 | WT20-100 | 14.3 | 0.9 | 2.7 | 67 | 84 | 52 | 82 | C | C | C |

### (*0) in Table 1

Monomer molar ratio=molar ratio of F atom-containing monomer/OH group-containing monomer/monomer not containing F atom, OH group, or COOH group/COOH group-containing monomer (*1) in Table 1

Ratio OH_{A}/NCO_{C1}=ratio of number of moles [OH_{A}] of OH groups of acrylic resin (a) to number of moles [NCO_{C1}] of NCO groups of multifunctional isocyanate (c1) (*2) in Table 2

Ratio OH_{PRE}/NCO_{C2}=ratio of number of moles [OH_{PRE}] of OH groups of prepolymer to number of moles [NCO_{C2}] of NCO groups of water-dispersible multifunctional isocyanate (c2)

As described in Tables, in each of Examples, a protective film is formed with an aqueous coating composition obtained by mixing, with a water-dispersible multifunctional isocyanate, an aqueous emulsion including an aqueous solvent and a prepolymer that is a reaction product of a multifunctional isocyanate and an acrylic resin having fluorine atoms and hydroxyl groups and having an acid value of 5 mgKOH/g or more and 100 mgKOH/g or less. As is clear from Tables, compared with Comparative Example in which the acrylic resin has an acid value of more than 100 mgKOH/g, these Examples provide protective films having high scratch resistance and high water resistance.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An aqueous emulsion comprising:
a prepolymer that is a reaction product of a multifunctional isocyanate and an acrylic resin having fluorine atoms and hydroxyl groups and having an acid value in a range of 5 mgKOH/g to 100 mgKOH/g; and
an aqueous solvent.

2. The aqueous emulsion according to claim 1, wherein the prepolymer has a hydroxyl value in a range of 120 mgKOH/g to 170 mgKOH/g.

3. The aqueous emulsion according to claim 1, wherein a ratio [OH_{A}/NCO_{C1}] of a number of moles [OH_{A}] of the hydroxyl groups of the acrylic resin to a number of moles [NCO_{C1}] of isocyanate groups of the multifunctional isocyanate is in a range of 2 to 40.

4. The aqueous emulsion according to claim 1, wherein the acrylic resin includes the fluorine atoms in a range of 0.1 mass % to 50 mass %.

5. The aqueous emulsion according to claim 1, wherein the acrylic resin is a polymer of
an ethylenic monomer having a fluorine atom,
an ethylenic monomer having a carboxyl group,
an ethylenic monomer having a hydroxyl group and a moiety that provides a side chain of the polymer and has 4 or more carbon atoms, and
an ethylenic monomer not having a fluorine atom, a carboxyl group, or a hydroxyl group.

6. The aqueous emulsion according to claim 1, wherein the acrylic resin is a polymer of
an ethylenic monomer having a fluorine atom,
an ethylenic monomer having a carboxyl group,
an ethylenic monomer having a hydroxyl group, and
an ethylenic monomer not having a fluorine atom, a carboxyl group, or a hydroxyl group,
wherein the prepolymer is a reaction product of the acrylic resin, the multifunctional isocyanate, and a polyol having a plurality of hydroxyl groups linked together via a carbon chain having 6 or more carbon atoms.

7. The aqueous emulsion according to claim 6, wherein the polyol is polycaprolactonepolyol.

8. The aqueous emulsion according to claim 6, wherein a mass ratio of the acrylic resin to the polyol is in a range of 20/80 to 80/20.

9. An aqueous coating composition comprising:
a prepolymer that is a reaction product of a multifunctional isocyanate and an acrylic resin having fluorine atoms and hydroxyl groups and having an acid value in a range of 5 mgKOH/g to 100 mgKOH/g,
a water-dispersible multifunctional isocyanate, and
an aqueous solvent.

10. A surface protective resin member comprising:
a reaction product of a water-dispersible multifunctional isocyanate and a prepolymer that is a reaction product of a multifunctional isocyanate and an acrylic resin having fluorine atoms and hydroxyl groups and having an acid value of 5 mgKOH/g or more and 100 mgKOH/g or less.

11. The surface protective resin member according to claim 10, wherein the surface protective resin member has a Martens hardness at 23° C. in a range of 0.5 N/mm² to 220 N/mm².

12. The surface protective resin member according to claim 10, wherein the surface protective resin member has a recovery ratio at 23° C. in a range of 70% to 100%.

13. The surface protective resin member according to claim 10, wherein the surface protective resin member has a surface contact angle with water in a range of 90° to 150°.

14. The surface protective resin member according to claim 10, wherein the surface protective resin member has a surface contact angle with oleic acid in a range of 55° to 70°.
